(19) United States
(12) Patent Application Publication
(10) Pub. No.: US 2006/0287997 A1
(43) Pub. Date: Dec. 21, 2006

(54) Pharmaceutical service selection using transparent data

(76) Inventor: Sooji Lee Rugh, Arlington, VA (US)

Correspondence Address: KOKKA & HSU, PC, 1001 N. RENGSTORFF AVE., SUITE 250, MOUNTAIN VIEW, CA, 94043-1748, US

(21) Appl. No.: 11/156,053

(22) Filed: Jun. 17, 2005

(51) Int. Cl. G06F 17/30

(52) U.S. Cl. 707/5

(57) ABSTRACT

Pharmaceutical service selection using transparent data is described, including retrieving data from a database, weighting the data to generate weighted information, evaluating the weighted information and feedback associated with the pharmaceutical service, and providing a rating for performance of the pharmaceutical service based on evaluating the weighted information and feedback for the pharmaceutical service.

### FIELD OF THE INVENTION

The present invention relates generally to software, communications, computer networks, and healthcare. More specifically, pharmaceutical service selection using transparent data is described.

### BACKGROUND OF THE INVENTION

Developing pharmaceutical drugs, products, compounds, medical devices, and other products that require approval by the U.S. Food and Drug Administration (“FDA”) is an expensive and timely process. Clinical testing of new drugs, compounds, and the like is significantly affected by the process of selecting investigative sites (“sites”) for performing controlled clinical trials. Sites may be organizations or individuals who conduct clinical trials of pharmaceutical and medical products for sponsors. Sponsors (i.e., corporations, institutions, entities, or individuals that develop products which require FDA approval such as pharmaceutical manufacturers, drug compound developers/manufacturers, medical device manufacturers, medical research entities and individuals, and the like) select sites for performing clinical trials based on particular criteria associated with the desired type of trial. However, conventional techniques for selecting sites are problematic.

Conventional site selection solutions include web directories and proprietary databases in addition to inter-personal networking mechanisms such as word-of-mouth and personal referrals. Conventional web directories such as CenterWatch developed by the Thomson Corporation of Boston, Mass. allow sponsors (e.g., Merck, Pfizer, Biogen Idec, and other pharmaceutical manufacturers) or contract research organizations (CRO; e.g., PPD of Wilmington, N.C.) to access a compiled list of sites. Web directories are information listing services or products that may be purchased, licensed, or subscribed to by a CRO or sponsor for the purpose of evaluating sites for trials. However, web directories do not provide performance, quality, or feedback information that is useful when selecting a site. Conventional web directories provide static lists of contact and general information about sites, but fail to provide performance information to sponsors or CROs for evaluating a site for a trial. For example, a site listing in a web directory does not list or emphasize the prescription-writing habits of its primary investigator (PI), who may be a physician with a highly-enrolled, but small practice. Likewise, proprietary applications such as AcuSite® developed by Acurian, Inc. of Horsham, Pa. and Investigator™ developed by Perceptive Informatics of Waltham, Mass. are also problematic.

Proprietary databases are generally created and populated with information from a narrow range of sources, typically by an individual sponsor, CRO, or vendor that owns the database. While contact information is listed, performance information can also be included, but generally only for sites that have worked with the sponsor, CRO, or vendor that owns the database. The range of information is often limited to the particular sponsor or CRO that owns or operates the database. Further, proprietary databases are not used collaboratively with other sponsor or CRO databases, which fails to expand the range of potential sites that a sponsor, CRO, or vendor may evaluate for a clinical trial.

Conventional implementations such as web directories and proprietary databases provide limited and inaccurate information to users searching for sites to conduct clinical trials of pharmaceutical or medical products. For example, conventional techniques may not reveal that a particular site has historically failed to enroll sufficient numbers of patients (i.e., subjects) to conduct a particular type of trial. Performance information in a web directory such as CenterWatch does not reflect the low enrollment rate and, if selected by a sponsor or CRO, a site may incur expensive time delays while attempting to enroll sufficient numbers of subjects. As another example, a proprietary database may have substantial performance information on a particular site, but if a sponsor or CRO does not have access to the proprietary database (i.e., non-collaborative implementation by another sponsor, CRO, or vendor), it may not be able to view and select a site that meets the criteria for a desired clinical trial. Further, sponsors and CROs tend to create and maintain private, proprietary databases and do not share them with competitors.

Thus, what is needed is a solution for selecting a clinical site without the limitations of conventional implementations.

### BRIEF DESCRIPTION OF THE DRAWINGS

Various embodiments of the invention are disclosed in the following detailed description and the accompanying drawings:

FIG. 1 illustrates an exemplary clinical trial system;

FIG. 2 illustrates an exemplary pharmaceutical service selection system;

FIG. 3 illustrates an exemplary pharmaceutical service selection user interface;

FIG. 4 illustrates an exemplary overall process for pharmaceutical service selection;

FIG. 5 illustrates an exemplary process for managing pharmaceutical service information;

FIG. 6 illustrates an exemplary process for managing pharmaceutical service information;

FIG. 7 illustrates an exemplary process for evaluating a pharmaceutical service; and

FIG. 8 is a block diagram illustrating an exemplary computer system suitable for evaluating a pharmaceutical service.

### DETAILED DESCRIPTION

The invention may be implemented in numerous ways, including as a system, a process, an apparatus, or as computer program instructions included on a computer readable medium such as a computer readable storage medium or a computer network wherein program instructions are sent over optical or electronic communication links. In general, the steps of disclosed processes may be performed in an arbitrary order, unless otherwise provided in the claims.

A detailed description of one or more examples is provided below along with accompanying figures. The detailed description is provided in connection with such examples, but is not limited to any particular embodiment. The scope is limited only by the claims and numerous alternatives, modifications, and equivalents are encompassed. Numerous specific details are set forth in the following description in order to provide a thorough understanding. These details are provided for the purpose of example and the described embodiments may be implemented according to the claims without some or all of these specific details. For the purpose of clarity, technical material that is known in the technical fields related to the embodiments has not been described in detail to avoid unnecessarily obscuring the description.

Evaluating, searching, and selecting pharmaceutical services such as investigative sites, CROs, vendors, and other entities involved with clinical trial testing may be performed by using data that is ubiquitous or transparent to users. The below-described techniques may be implemented in order to evaluate a pharmaceutical service for purposes of conducting clinical trials. In some examples, pharmaceutical services may include clinical research investigative sites, clinical investigators, contract research organizations (CRO), sponsors (e.g., pharmaceutical manufacturers, biotechnology companies, drug compound manufacturers, medical device manufacturers, research entities, individuals performing pharmaceutical or medical research or manufacturing, and the like), central and local institutional review boards (IRB), vendors (e.g., equipment, laboratory, and service vendors), and others. Using qualitative and quantitative data associated with each pharmaceutical service, a selection may be made by weighting the data and evaluating feedback associated with the service, including previous (i.e., historical) trial data, site metrics (i.e., site trial performance information), and profile information. Profile information includes data, information, statistics, characteristics, feedback, comments, and the like, which are provided by the pharmaceutical service (e.g., site). Profile information may also include the type of site, equipment on site, level and types of technology implemented at the site, therapeutic or sub-therapeutic areas, and other information as described above. By providing users with techniques with ubiquitous information and data, accurate selection of a pharmaceutical service may be performed to increase efficiency and decrease costs associated with clinical trials.

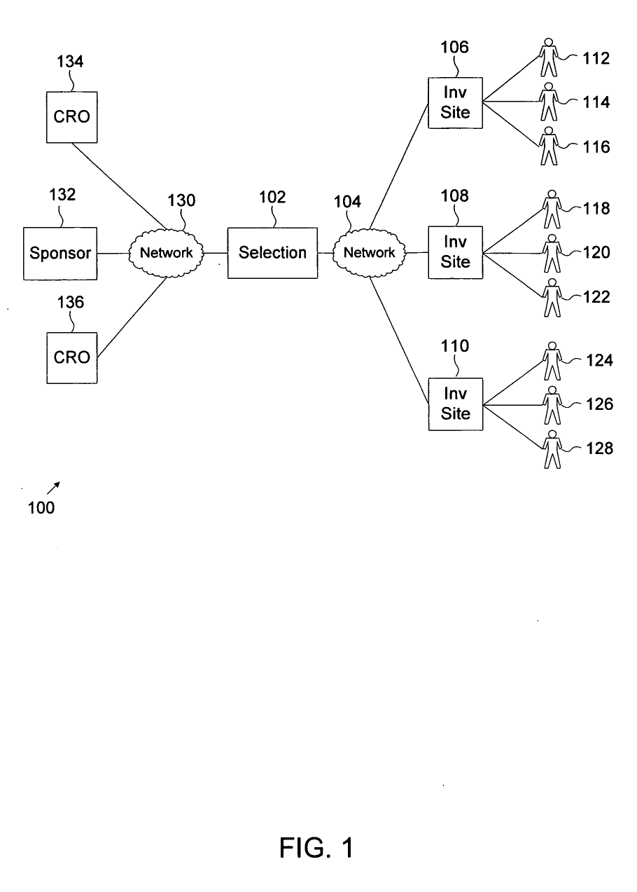

FIG. 1 illustrates an exemplary clinical trial system. Here, system 100 includes selection module 102, network 104, investigative sites (“sites”) 106-110, enrolled subjects 112-128, network 130, sponsor 132, and CROs 134-136. Selection module 102 may be used to select various types of pharmaceutical services for participation in clinical trials. In some examples, sites 106-110 may be selected for a clinical trial using system 100. In other examples, CROs 134-136 may be selected using system 100 to find other investigative sites for conducting clinical trials. In still other examples, system 100 may be used to select vendors, sponsors, or other organizations or individual involved with clinical trials at various phases. Data and information may be shared between selection module 102, sites 106-110, sponsor 132, and CROs 134-136. Data may be transferred across networks 104, 130. In other examples, data may also be shared via direct data communication links (not shown) between selection module 102, sites 106-110, sponsor 132, and CROs 134-136. The numbers of CROs, sponsors, site selection modules, and sites may be varied and are not limited to the implementation shown.

In some examples, sites 106-110 enroll subjects 112-128 who are included in a clinical trial. The numbers of subjects 112-128 may be varied and are not limited to the examples shown. Here, selection module 102 provides and arbitrates information and data between sponsor 132, CROs 134-136, and sites 106-110 during the site selection process. Sites 106-110 may provide information relating to the performance of active or previous trials. Trial feedback, profile (e.g., contact information, description/type of site, institutional review board (IRB) type, therapeutic/sub-therapeutic areas, geographic regions, enrolled subjects, electronic data capture (EDC) experience, equipment, technology, certifications, subject recruitment sources, clinical trial phases, performance or quality ratings, and the like), and other information may be referred and evaluated from selection module 102 by a sponsor, CRO, or vendor when evaluating the site for conducting a clinical trial.

Selection module 102 may be used to create, manage, or modify profile information such as that described above for each of sites 106-110. An administrative user (e.g., “sysadmin”) for each of sites 106-110 may log into selection module 102 to perform administrative tasks (e.g., updating profile information), respond to feedback, or leave qualitative or quantitative information that may be evaluated by sponsors, CROs, or vendors when considering a site for a particular trial. In some examples, sites 106-110 may input information to selection module 102 in order to create, manage, or modify its own profile. Information may also be input from each of sites 106-110 as responses to feedback, which may include information associated with previous clinical trials for either sponsor 132 or CROs 134-136. Information may also be input from sites 106-110 for other purposes and are not limited to those described above. Information input from sites 106-110 is transferred across network 104 and stored in a database or data storage device (e.g., storage area network (SAN), network attached storage (NAS), and the like) associated with selection module 102. In other examples, sites 106-110 may be in direct data communication with selection module 102 and not use network 104, which may be implemented using a WAN, LAN, MAN, WLAN, and the like. In still other examples, subjects 112-128 associated with sites 106-110 may also input or review information associated with sites 106-110, sponsor 132, or CROs 134-136. Likewise, data associated with sites 106-110 may be reviewed, modified, or input by sponsor 132 or CROs 134-136.

Here, sponsor 132 and CROs 134-136 may use selection module 102 to evaluate and select one or more of sites 106-110. In other examples, users may evaluate other types of pharmaceutical services, including sponsors, CROs, vendors, or others as described above. Implementation of site selection system 100 is not limited to the example shown and may be used to evaluate and select other types of pharmaceutical services in addition to clinical investigative sites.

Data or information may be transferred from sponsor 132 or one or more of CROs 134-136 across network 130 to selection module 102. In some examples, data or information such as feedback regarding a particular clinical trial involving one or more of sites 106-110 may be sent to selection module 102 and made available for review by various users, including other sponsors, CROs, sites, or subjects (regardless of whether enrolled or not). By enabling information associated with clinical sites for review and evaluation during the site selection process, the effectiveness and efficacy of trials may be increased.

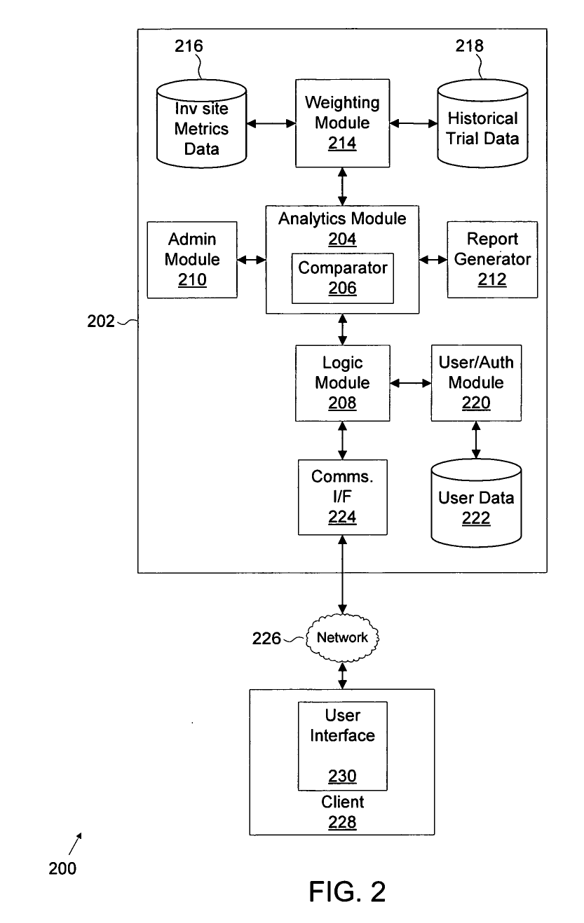

FIG. 2 illustrates an exemplary pharmaceutical service selection system. In some examples, selection module 102 may be implemented using selection module 202. Here, system 200 includes selection module 202, analytics module 204, comparator 206, logic module 208, administrative module 210, report generator 212, weighting module 214, investigative site metrics database 216, historical trial database 218, user/authentication module 220, user data module 222, communications interface 224, network 226, client 228, and client user interface (“UI”) 230. In other examples, the implementation of system 200 may be varied.

In some examples, selection module 202 performs various processes that enable users to evaluate a pharmaceutical service (i.e., an investigative site) for conducting a clinical trial. When a user (e.g., another site, sponsor, CRO, vendor, subject considering enrollment, institutional review board (IRB), pharmaceutical service, or others) evaluates a site, selection module 202 may be used to implement logic for executing various functions that retrieve, generate, and display information that may be reviewed by the user. Analytics module 204 evaluates performance information such as investigative site metrics database 216 and historical trial database 218. Other types of data may be evaluated by analytics module 204. During the evaluation of a pharmaceutical service, data is retrieved from either, one, or both of investigative site metrics database 216 or historical trial database 218, and compared by comparator 206, and analyzed by analytics module 204 and output to logic module 208. When a site is evaluated, performance information is retrieved from investigative site metrics database 216 and historical trial database 218. In other examples, performance information may be stored in a separate database, repository, or storage location. Here, performance information is retrieved, weighted, and compared by comparator 206. In some cases, a user (e.g., sponsor, CRO, site, selection module 202 administrator, and others) may manipulate weighting module 214 to provide greater emphasis on particular sub-categories or criteria (e.g., assigning a larger weight factor to geographic region of a site in order to locate sites with enrolled subjects from a particular region for demographic or other reasons).

As an example, a user on client 228 may log into selection module 202 via client UI 230. Data is transferred over network 226 via communications interface 224 to selection module 202 using a data communication protocol (e.g., TCP/IP, UDP, ATM, Frame relay, and the like). Once authenticated by user/authentication module 220 using data from user database 222, an authenticated user is allowed to add, modify, delete, or specify data, parameters, criteria, or other factors that may weight historical trial data and investigative site metrics data. Authenticated users include system administrators for sites 106-110, sponsor 132, CROs (134-136), vendors (not shown), or others. After a user has logged into system 200 and selection module 202, searches may be conducted to find a pharmaceutical service that is suited for a particular trial. Information from system 200 may be used during the searches.

In some examples, different types or categories of investigative site metrics data may be weighted differently. For example, investigative site metrics database 216 may include information such as characteristics that specify therapeutic and sub-therapeutic areas, IRB type, region, electronic data capture (EDC) experience, site type, phase, equipment, certification(s), technology experience/expertise, subject recruitment source(s), ratings, feedback, and other information associated with each site. Historical trial database 218 may also include performance information (e.g., ratings) from previous clinical trials performed by a site. Performance information is described in greater detail below.

Users may perform searches by specifying one or multiple characteristics such as those described above. In some examples, a search may be performed based on entering a characteristic (e.g., therapeutic area) and a rating as the desired search criteria. In other examples, a search may be performed using either basic or advanced search criteria. Basic search criteria may be a set of characteristics used regardless of the type of pharmaceutical service. Advanced search criteria may be a set of characteristics used for a particular type of pharmaceutical service (e.g., sites, CROs, sponsors, vendors, and others). In other examples, the search techniques may be varied differently and are not limited to those described above. Searches may use information from various databases within system 200 and are not limited to the example shown. Here, system 200 may be used to evaluate, search, and select a site. In other examples, system 200 may also be used to evaluate, search, and select other pharmaceutical services (e.g., CROs, sponsors, vendors, or others) and is not limited to the implementation shown.

The information (i.e., characteristics) stored in investigative site metrics database 216 and historical trial database 218 may also be weighted in order to filter or determine the most appropriate sites (or other pharmaceutical services). For example, a rating assigned to a pharmaceutical service (e.g., site, CRO, vendor, sponsor) may be weighted based on the phase of a trial. A numerical weight may be determined from the use of a weighted decision “tree,” matrix, algorithm, or construct in order to vary the numerical weight of a rating assigned to a pharmaceutical service. Various types of decision trees, matrices, algorithms, or constructs may be used and are not limited to only the examples given. Other information such as the duration of a trial may also be used to determine a numerical weight for a rating. The weighting of this information takes into account differences between trials performed for different phases of the clinical trial process (e.g., phase I, phase II, phase III, and the like). Additionally, the duration of a trial may reflect internal problems during a trial such as subject retention, which may be more heavily weighted for a trial having a longer duration than another trial. Other types of information may also be evaluated, including performance information.

Performance information may be qualitative or quantitative data or information that enables users to evaluate and assess a level of quality for a particular site (i.e., pharmaceutical service). In some examples, a rating (e.g., a numerical value, a graphical icon (e.g., star), a color, and the like) may be associated with the profile information of a pharmaceutical service, providing users with a standard or benchmark for assessing quality or suitability for a particular type of trial. In some examples, ratings may be qualitative, quantitative, or a combination of both, enabling sites, sponsors, CROs, and other users to passively or actively review another pharmaceutical service. As an example, a rating system may generate and display a graphical icon on client user I/F 230 that provides an indication of the level of overall quality of a site with regard to a specific type of clinical trial. Ratings may be established based on verified qualitative (e.g., feedback) or quantitative (e.g., statistical performance information) information that enables performance assessment for a pharmaceutical service (i.e., site). Ratings may be affected by quantitative information such as the percentage of randomized subjects in relation to the contract (i.e., trial) goal, the number of evaluated subjects (i.e., subjects who completed the trial or study), data clarification form (DCF) percentage of the site compared to the mean DCF percentage of the trial, and the like. As an example, a trial may have an expected number of DCFs that provide amplifying or clarifying information about a trial. Each site may have an individual amount of DCFs, which may be expressed as a percentage in relation to the expected number of DCFs for the trial. The percentage of each site may be compared to a mean DCF percentage for the trial and compared using a standard deviation, D. If a site has greater than a 2D deviation from the mean DCF trial percentage, then the site DCF percentage may be weighted to reflect a poor performance metric. Conversely, if a site has less than the standard deviation from the mean DCF trial percentage, then the site DCF percentage may be weighted to reflect a higher performing site and a higher rating would result. In the former example, the site (or other pharmaceutical service) may experience a low rating, which may affect its attractiveness as a suitable trial service. In the second example, a higher rating may result in more accurate profiling of the pharmaceutical service, resulting in a more accurate and efficient trial as less data clarification is required for the higher rated service, which may be due to operating protocols, personnel standards quality, trial experience, or other factors. Ratings may also be weighted, as discussed above. Qualitative information such as feedback may also be considered when assigning a rating to a pharmaceutical service.

If pharmaceutical services (e.g., sponsors, CROs, sites, vendors) use selection module 202 to leave qualitative (i.e., feedback) for a site that conducted a clinical trial (or another pharmaceutical service), a feedback system may also be implemented that allows the owner, administrator, investigator, or operator of the assessed pharmaceutical service to generate a response, dispute, publish, or highlight the feedback. Some examples of factors that may be included in feedback are PI availability, site responsiveness, protocol deviation (i.e., sponsor-drafted, FDA-approved protocols that govern the conduct of clinical trials), level of queries (e.g., site DCF percentage compared to the mean DCF percentage of the trial), and other types of qualitative and quantitative data based on a site's performance and conduct of a clinical trial. In some examples, responses to feedback may be qualitative or quantitative information that is associated with the feedback. In other examples, an administrator of system 200 may narrow or expand the range of responses that may be made to feedback (e.g., limiting responses to comments, enabling quantitative data to be added in order to be reviewed by other pharmaceutical services in association with a rating (i.e., a “counter rating”), and the like). In some examples, user confidence and information integrity may be preserved by preventing the modification of feedback, once verified (i.e., confirmed as accurate and neither misleading nor malicious) by users other than the original user who left the feedback. Additionally, by enabling information (e.g., types described above) to be viewed by the various types and categories of users (e.g., sponsors, CROs, sites, vendors, and the like), ubiquity or transparency enables system users to access, review, and assess common information using standard performance benchmarks (e.g., ratings) to aid the determination of an appropriate pharmaceutical service for a particular role in a clinical trial (e.g., finding a CRO to locate sites or directly locating sites to conduct a clinical trial). This leads to increased user confidence and improves the efficiency and accuracy of pharmaceutical service selection using system 200. Further, costs may be lowered by more efficiently and accurately selecting sites that are able to meet clinical trial requirements (e.g., achieve desired percentages of enrolled subjects) without incurring time-consuming and expensive delays.

Here, logic module 208 and the above-described elements of system 200 may be implemented using software, hardware (e.g., processors, circuitry, and the like), or a combination of both to provide logical processes for enabling the evaluation and selection of sites for clinical trials. In some examples, software may be used to implement algorithms or rule-based decision-making that is used to yield a particular site when a site search is executed using weighted data from weighting module 214. In some examples, logic module 208 may also be used to implement logical processes for controlling system 200 and the above-described modules. Implementation of system 200 may be varied and is not limited to the examples shown and described.

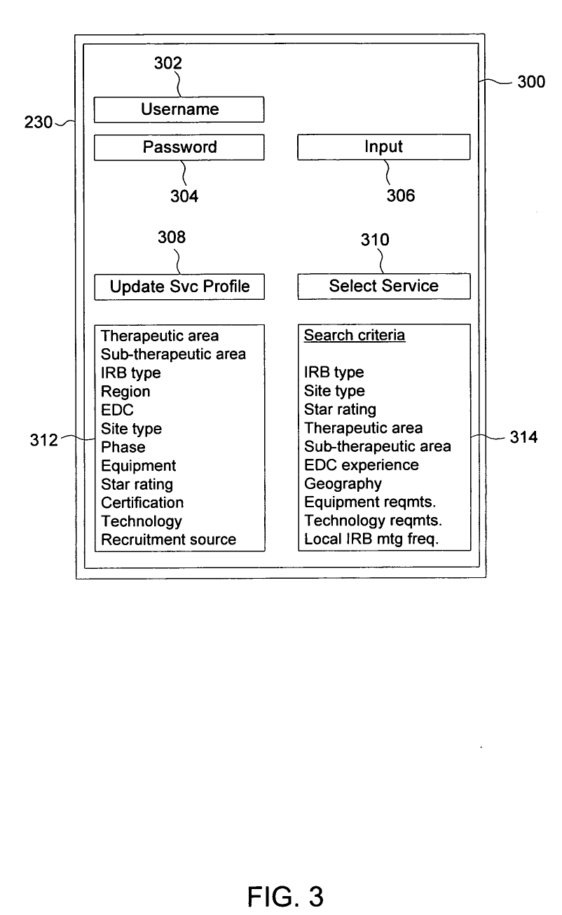

FIG. 3 illustrates an exemplary pharmaceutical service selection user interface. In this example, an exemplary graphical user interface (GUI) 230 is shown. In 304, input field 306, service (i.e., pharmaceutical service) function field 308, service (i.e., pharmaceutical service) selection field 310, service (i.e., pharmaceutical service) profile category window 312, and search criteria window 314. Display 300 may be used to visually represent information or data on a screen at client 228. Display 300 may include interactive elements (e.g., hyperlinks, link-enabled text or icons, scripts, and other executable program or program elements) for a user to read and input information. In general, a field may be a portion of display 300 where data may be input by a user and window may be a portion of a display where information generated by selection module 202 (FIG. 2) is displayed for a user to review.

Here, username field 302 and password field 304 provide entry spaces for a user to enter a username and password that may be authenticated by user/authentication module 220. In other examples, information or data input from a user may be entered in input field 306. If a user (e.g., sponsor, CRO, or vendor) updates a profile (i.e., a set of data, information, and characteristics associated with a site), a particular category of profile information may be selected from site profile category window 312. If a user initiates a search for a service, search criteria may be selected from the field of criteria implemented differently, including varying functions, sizes, shapes, categories, types, appearances, display settings, or other parameters for representing text, graphical, and color-based information on display. Other examples may be implemented using varying features and functions and are not limited to those described above.

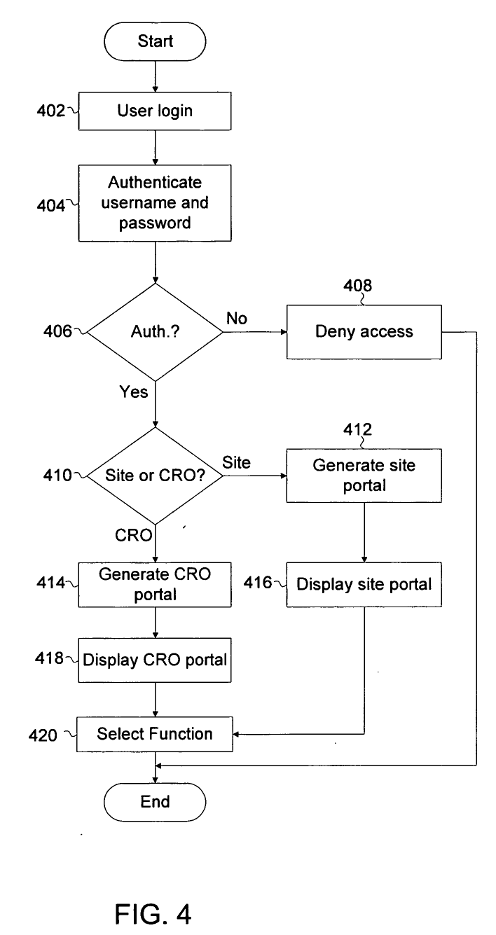

FIG. 4 illustrates an exemplary overall process for pharmaceutical service selection. In some examples, an overall process for service selection may be initiated by logging into selection module 202 (FIG. 2) (402). After entering a username and password, authentication is performed (404). In some examples, authentication may be performed upon a first log-in and a cookie (i.e., a small data file that may be used to identify an authenticated client on subsequent log-ins) may be stored on client 228. In other examples, different types of data security may be used to ensure authorized users are permitted access and unauthorized users are denied entry to information on system 200. These may include authentication, encryption, and other data security techniques. A determination is made by logic module 208 and user/authentication module 220 (FIG. 2) to determine if authentication was successful (406). If a user is not authenticated, access is denied (408). If a user is properly authenticated or permitted access, then another logic module 208 (FIG. 2) determines the user type (e.g., site vs. sponsor, CRO, vendor, or another pharmaceutical service) (410). If the user is a site, then a site portal is display or screen that provides text and graphical information that are associated with the site for the authenticated user. In other examples, a site portal may be a general display with several features or functions that allow a user to add, modify, or delete information associated with the profile for the authenticated user's site. In still other examples, different portals may be generated and displayed for different types of users (e.g., CROs, vendors, sponsors, or others). As an example, a site investigator may log into selection module 102 in order to respond to feedback left by a sponsor from a previous clinical trial. After the user has been authenticated, she may leave comments or feedback that is processed by logic module 208 and analytics module 204 (FIG. 2) in order to generate an overall rating for the site. In other examples, a site portal may be varied apart from the implementation described above.

Likewise, if a user is authenticated as a sponsor, CRO, vendor, or type of user 2) (414). Once the type of user is determined, the site portal may be displayed at client function associated with a particular feature of either a site portal or a sponsor/CRO/vendor/other portal (420). In other examples, processes for site selection may be implemented differently and are not limited to those described above.

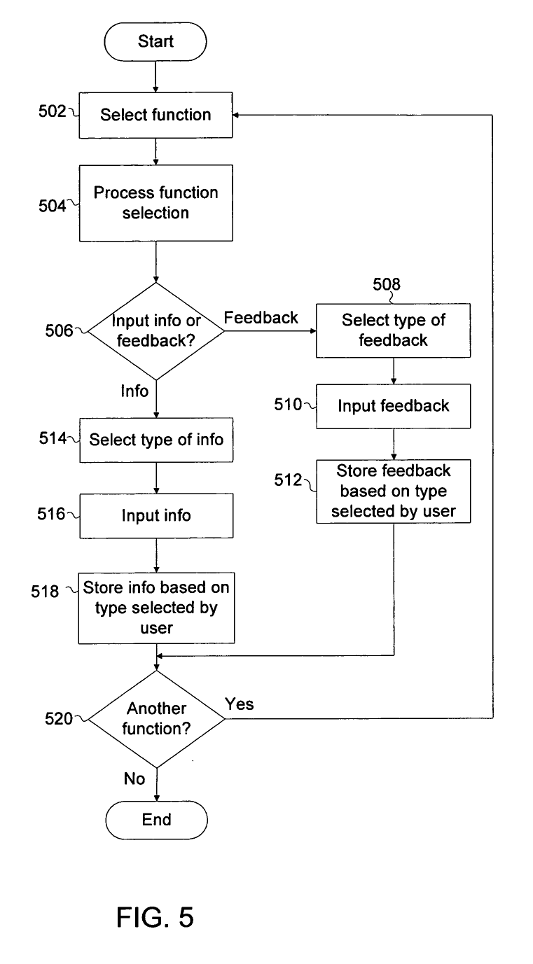

FIG. 5 illustrates an exemplary process for managing pharmaceutical service information. Here, a process for managing information associated with a site profile is described. In other examples, the illustrated process may be used to manage information associated with other types of pharmaceutical services. A user may select a function for adding, deleting, or modifying information associated with a site profile, feedback, performance history, ratings, and the like. Once authenticated, a user may be granted access to site information stored on selection module 202 (e.g., investigative site metrics database 216 (FIG. 2) (502). After selecting a function, logic module 208 processes the selected function (504). In some examples, selection module 202 determines whether the selected function involves adding, modifying, or deleting information associated with a site profile or responding to feedback left by a sponsor, CRO, vendor, or user other than the site (506). In some examples, feedback may be entered by a user providing information relating to a clinical trial that the site performed. If the selected function involves feedback, then the type of feedback may be selected (508). After selecting the type of feedback, information is input (510). Once the information has been entered or input by the user, the information is stored on selection module 202 (512). Information associated with feedback or responses to feedback may be stored in historical trial database 218 or another database, repository, or storage system.

Likewise, if the selected information indicates the addition, modification, or deletion of information (e.g., site, CRO, sponsor, or vendor profile information such as those characteristics described above in connection with FIG. 2) and not feedback, then the type of information to be input is selected (514). Once the type of information has been selected, the information is entered by the user (516). After entering the information, the information may be stored on selection module 202 (518). Information may be stored in investigative site metrics database 216 or another database, repository, or storage system. After completing the desired function, the user may be prompted to perform another function (520). If another function is desired, then the above-described process repeats. If no additional function is desired, then the process ends. In other examples, the process(es) for managing site information may be varied and is not limited to the functions or sub-processes described.

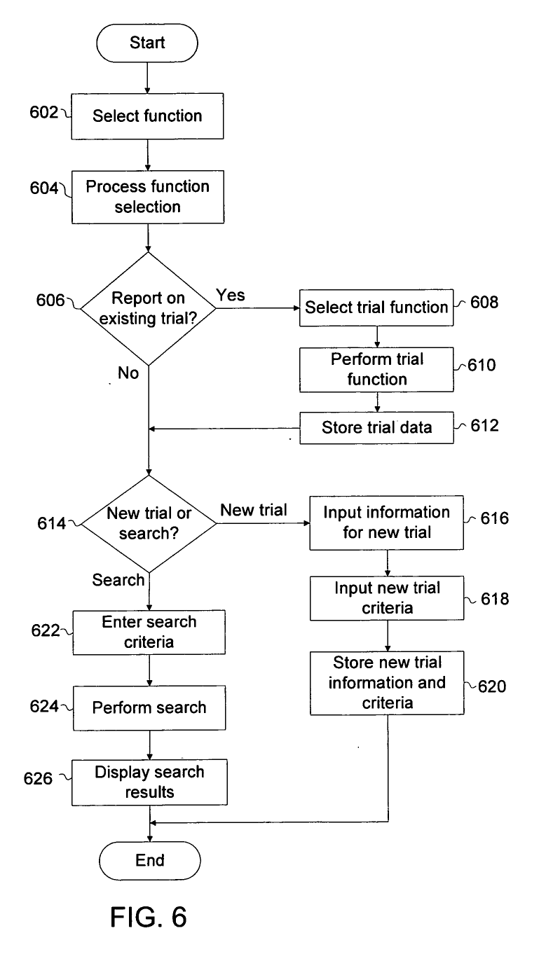

FIG. 6 illustrates an exemplary process for managing pharmaceutical service information. Here, information related to clinical trials performed by a site may be managed by an authenticated user. Also, information relating to other users (e.g., CROs, sponsors, vendors, or others) involved with clinical trials may also be managed using the described process. An authenticated user selects a function (602). Once selected, the function is processed (i.e., by logic module 208, analytics module 204, or another module) (604). Once processed, a determination is made as to whether a report is being requested for an existing trial (606). If a report is desired, then the user selects a trial function (608). Once a trial function has been selected, the trial function is performed (610). Data resulting from the performance of the trial function is stored in historical trial database 218 (612). In other examples, data output from trial functions may be stored in other locations or on other modules or systems. A determination is made as to whether a new trial is being established or whether a search for a pharmaceutical service is to be performed (614).

If a sponsor, CRO, vendor, or other user is establishing a new trial, information for the new trial is input (616). Trial criteria may also be entered for pharmaceutical services to evaluate when determining whether to pursue a contract to perform the clinical trial for the sponsor, CRO, or vendor (618). New trial information may include the type of trial, geographic region, desired types of equipment, therapeutic area, and other information may be input to create a trial profile. Once entered, the new trial information and criteria may be stored in selection module 202 (FIG. 2) (620).

If a site search is selected (i.e., a user is running a search for a particular site to match with a particular type of clinical trial), a user is prompted to enter search criteria (622). Search criteria may be entered in various forms including keyword, Boolean, and others. After search criteria have been entered, a search is executed by logic module 208, which evaluates data stored in investigative site metrics database 216 and historical trial database 218 to find sites that match the search criteria (624). In some examples, search functionality may be implemented using functionality other than that described for logic module 208. Here, after the search is completed, results may be displayed at client U/I 230 (FIG. 2) (626). In other examples, the above-described process may be varied and is not limited to the examples described.

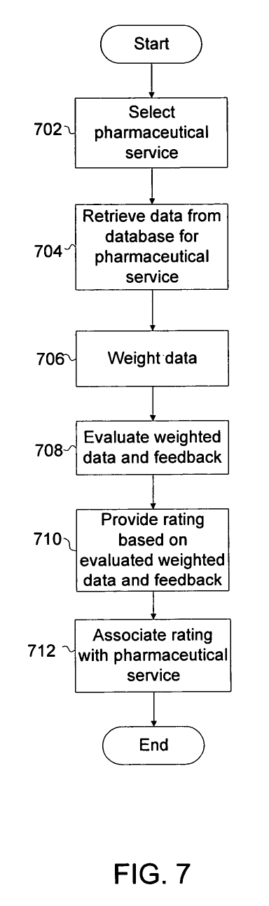

FIG. 7 illustrates an exemplary process for evaluating a pharmaceutical service. Here, an alternative example of a process for evaluating performance of a pharmaceutical service is described. A pharmaceutical service is selected from a group of pharmaceutical services stored on a selection system (e.g., system 200) (702). Once selected, data is retrieved from a database for the selected pharmaceutical service (704). The data retrieved for the pharmaceutical service is weighted (706). After weighting the data, the weighted data is evaluated along with feedback, if any, provided for the selected pharmaceutical service (708). Based on the evaluation of the weighted data and feedback, a rating may be assigned to the pharmaceutical service (710). In some examples, the rating may be text or graphics (e.g., star, color, avatar, or other graphical image or icon) representing information associated with the pharmaceutical service. For example, a gold star may represent a high rating of quality for the pharmaceutical service. The rating may be generated as a result of evaluating quantitative (i.e., weighted data) and qualitative (feedback from sponsors, CROs, vendors, and the like) to yield a rating. After generating (i.e., providing) the rating, it is associated with the pharmaceutical service (712). The rating may be stored with profile information for the pharmaceutical service as well as used to index the pharmaceutical service in future searches or evaluations.

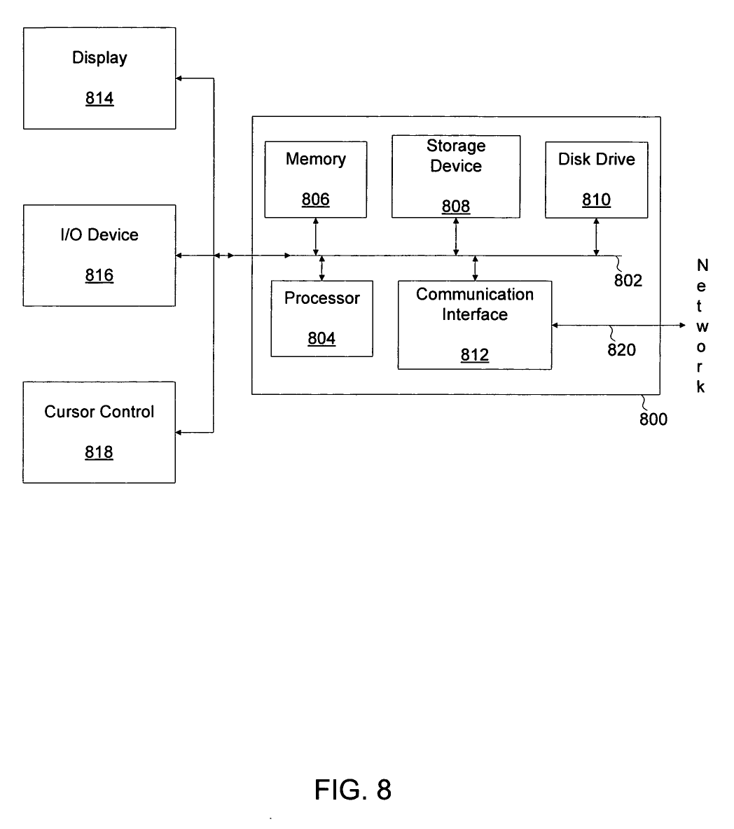

FIG. 8 is a block diagram illustrating an exemplary computer system suitable for evaluating a pharmaceutical service. In some embodiments, computer system 800 may be used to implement computer programs, applications, methods, or other software to perform the above-described techniques for fabricating storage systems such as those described above. Computer system 800 includes a bus 802 or other communication mechanism for communicating information, which interconnects subsystems and devices, such as processor 804, system memory 806 (e.g., RAM), storage device 808 (e.g., ROM), disk drive 810 (e.g., magnetic or optical), communication interface 812 (e.g., modem or Ethernet card), display 814 (e.g., CRT or LCD), input device 816 (e.g., keyboard), and cursor control 818 (e.g., mouse or trackball).

According to some embodiments of the invention, computer system 800 performs specific operations by processor 804 executing one or more sequences of one or more instructions stored in system memory 806. Such instructions may be read into system memory 806 from another computer readable medium, such as static storage device 808 or disk drive 810. In some embodiments, hard-wired circuitry may be used in place of or in combination with software instructions to implement the invention.

The term “computer readable medium” refers to any medium that participates in providing instructions to processor 804 for execution. Such a medium may take many forms, including but not limited to, non-volatile media, volatile media, and transmission media. Non-volatile media includes, for example, optical or magnetic disks, such as disk drive 810. Volatile media includes dynamic memory, such as system memory 806. Transmission media includes coaxial cables, copper wire, and fiber optics, including wires that comprise bus 802. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some embodiments of the invention, execution of the sequences of instructions to practice the invention is performed by a single computer system 800. According to some embodiments of the invention, two or more computer systems 800 coupled by communication link 820 (e.g., LAN, PSTN, or wireless network) may perform the sequence of instructions to practice the invention in coordination with one another. Computer system 800 may transmit and receive messages, data, and instructions, including program, i.e., application code, through communication link 820 and communication interface 812. Received program code may be executed by processor 804 as it is received, and/or stored in disk drive 810, or other non-volatile storage for later execution.

Although the foregoing embodiments have been described in some detail for purposes of clarity of understanding, implementations of the above-described system and techniques is not limited to the details provided. There are many alternative implementations and the disclosed embodiments are illustrative and not restrictive.

What is claimed:

1. A method for evaluating a pharmaceutical service, comprising:
retrieving data from a database;
weighting the data to generate weighted information;
evaluating the weighted information and feedback associated with the pharmaceutical service; and
providing a rating for performance of the pharmaceutical service based on evaluating the weighted information and feedback for the pharmaceutical service.

2. The method of claim 1, wherein the data includes site metrics data.

3. The method of claim 1, wherein the data includes trial data.

4. The method of claim 1, wherein the data includes site metric data and trial data.

5. The method of claim 4, further comprising evaluating the site metric data and trial data to determine the rating for the pharmaceutical service.

6. The method of claim 1, wherein the pharmaceutical service is an investigative site.

7. The method of claim 1, wherein the pharmaceutical service is a sponsor.

8. The method of claim 1, wherein the pharmaceutical service is a vendor.

9. The method of claim 1, wherein the pharmaceutical service is a contract research organization.

10. The method of claim 1, wherein evaluating the weighted information and feedback includes analyzing qualitative and quantitative data provided by the pharmaceutical service or another pharmaceutical service.

11. The method of claim 1, wherein the feedback includes historical data associated with the performance of the pharmaceutical service.

12. The method of claim 1, wherein weighting the data further comprises assigning a weight factor to profile information associated with the pharmaceutical service.

13. The method of claim 1, wherein weighting the data further comprises assigning a weight factor to trial information associated with the pharmaceutical service

14. The method of claim 1, wherein weighting the data further comprises assigning a weight factor to profile information associated with the pharmaceutical service.

15. The method of claim 1, wherein weighting the data further comprises using a metric associated with a trial performed by the pharmaceutical service.

16. The method of claim 1, wherein weighting the data further comprises using performance information associated with the pharmaceutical service.

17. The method of claim 1, wherein providing the rating for the performance of the pharmaceutical service includes associating the rating with a profile of the pharmaceutical service.

18. The method of claim 1, wherein a report is generated using the rating, profile information, and performance information associated with the pharmaceutical service.

19. A system for evaluating a pharmaceutical service, comprising:
a database for storing data associated with the pharmaceutical service; and
a logic module configured to retrieve the data from the database, determine a weight factor for the data and generate weighted information from the weighted data using the weight factor, evaluating the weighted information and feedback associated with the pharmaceutical service, and provide a rating for the pharmaceutical service based on evaluating the weighted information and the feedback for the pharmaceutical service.

20. A computer program product for evaluating a pharmaceutical service, the computer program product being embodied in a computer readable medium and comprising computer instructions for:
retrieving data from a database;
weighting the data to generate weighted information;
evaluating the weighted information and feedback associated with the pharmaceutical service; and
providing a rating for performance of the pharmaceutical service based on evaluating the weighted information for the pharmaceutical service.
